(19) United States
(12) Patent Application Publication
(10) Pub. No.: US 2009/0310346 A1
(43) Pub. Date: Dec. 17, 2009

(54) GENERAL LED LIGHTING IN INSULATED GLASS WITH IMPROVED ENERGY MANAGEMENT

(75) Inventor: Peter Alexander Wachters, Eindhoven (NL)

Correspondence Address: Philips Intellectual Property and Standards, P.O. Box 3001, Briarcliff Manor, NY, 10510-8001, US

(73) Assignee: KONINKLIJKE PHILIPS ELECTRONICS N.V., Eindhoven (NL)

(21) Appl. No.: 12/376,155

(22) PCT Filed: Aug. 29, 2007
(86) PCT No.: PCT/IB07/53470

§ 371 Date: Feb. 3, 2009

(30) Foreign Application Priority Data
Aug. 31, 2006 (EP) 06119866.9
Mar. 23, 2007 (EP) 07104723.7

(51) Int. Cl. F21V 9/00; F21V 29/00; F21V 21/00

(52) U.S. Cl. 362/231; 362/373; 362/227

(57) ABSTRACT

The present invention provides a lighting assembly for interior lighting. The lighting assembly (1) comprises first and second panes (10, 14) spaced apart from each other by a thermally insulating means (12). Lighting means (16) are arranged at the first pane (10) to direct light in one direction and to direct heat in a different direction, mainly in the opposite direction. The lighting assembly can be used in e.g. windows for providing interior lighting while avoiding conduction of heat via the interior face of the window.

### FIELD OF THE INVENTION

The present invention relates to a lighting assembly comprising lighting means, and first and second panes separated from each other by a thermally insulating means. In particular, the lighting assembly can be used as a window element for general lighting applications such as interior lighting for buildings, automobiles and greenhouses.

### BACKGROUND ART

Interior lighting is usually required to create comfortable working and leisure environments in e.g. buildings, automobiles or any other interior applications. Interior lighting is used to provide adequate lighting conditions, in particular when the amount of daylight becomes insufficient. However, it is known that interior lighting is a heat generator due to its power radiating nature. Over the last decennia, the overall heat generated by interior lighting has increased significantly.

In most applications, heat generated by interior lighting has to be carried off from the interior in order to maintain a comfortable indoor temperature. However, heat conduction, by e.g. operation of fans and air conditioners, requires additional expensive equipments, space and energy. Thus, there is a need for providing new interior lighting devices and systems that would overcome these problems.

### SUMMARY OF THE INVENTION

An object of the present invention is to wholly or partly overcome the above disadvantages and drawbacks of the prior art and to provide a more efficient alternative to the above techniques and prior art. More specifically, it is an object of the present invention to provide a lighting assembly enabling interior lighting while minimizing interior generation of heat.

The present invention is based on the understanding that lighting means can be arranged in a lighting assembly in such a way that light emitted from the lighting means of the lighting assembly is directed in one direction and heat generated by the lighting means of the lighting assembly is directed in a different direction, preferably in the opposite direction.

Hence, a lighting assembly is provided, comprising a first pane, a second pane and lighting means, wherein the first and second panes are spaced apart from each other by thermally insulating means and the lighting means are arranged at the first pane to direct light emitted from the lighting means in a direction towards the second pane and to direct heat generated by the lighting means in a different direction.

The inventive lighting assembly is advantageous in that interior generation of heat is minimized since the transfer of heat generated by the lighting means to the second pane is minimized. The present lighting assembly therefore offers an efficient solution for saving energy in interior lighting. Further, using the lighting assembly e.g. as a window provides a cost effective solution when constructing a house or a building. When the first pane is exposed to outside air, the heat generated by the lighting means is transferred via the first pane to the outside air and very little heat is transferred to the second pane, i.e. to the interior of a building if the lighting assembly is used as a window in a building.

The first and second panes of the lighting assembly may have parallel surfaces, which is advantageous in building operations when the lighting assembly is to be combined with other elements.

The first and second panes may be light-transmissive, which is advantageous since exterior light sources, such as e.g. daylight or any other light sources, may be used to generate additional interior light.

The first pane may be composed of material of high thermal conductivity in order to effectively transfer the heat generated by the lighting means of the lighting assembly to the outside of the assembly.

The insulating means may be at least one of the group comprising a material of low thermal conductivity, vacuum and a gas of low thermal conductivity for minimizing heat transfer from the lighting means arranged at the first pane to the second pane.

The second pane of the lighting assembly may be arranged as a plurality of panes arranged in layers.

The first pane of the lighting assembly may be arranged as a single pane at which the lighting means are arranged. However, the first pane may alternatively comprise a plurality of panes arranged in layers in order to further minimize the heat transfer from the first pane to the second pane.

The first pane of the lighting assembly may comprise at least two separate panes arranged in layers between which the lighting means are arranged. This structure is advantageous since the lighting means may be encapsulated between the at least two layers and thereby be protected from difficult outside environment such as humidity.

The lighting assembly may comprise a reflective layer arranged between the thermally insulating means and the second pane for reflecting infrared radiation generated by the lighting means towards the first pane, which is advantageous in that it reduces the transfer of heat generated by infrared radiation from the lighting means towards the second pane, i.e. towards the interior.

The lighting means of the lighting assembly may be light emitting diodes, which is advantageous since light emitting diodes used for lighting purposes produce a small amount of infrared radiation as compared to other light sources. Further, light emitting diodes producing a small amount of ultraviolet radiation may be selected for lighting in environment such as museums or exhibit centres in which objects like paintings should rather not be exposed to ultraviolet radiation. The use of light emitting diodes is advantageous for building applications since they have a rather long lifetime as compared to most common light sources.

The lighting means of the lighting assembly may comprise at least one diode of the group comprising low-power diodes for avoiding glare, high-power diodes for directing light, and red, green and blue (RGB) diodes for creating an illuminating surface emitting white light.

The level of light output may be high to illuminate an object. However, the level of light output may even be low such that a decorative effect is reached, rather than illuminating an object.

The lighting assembly may comprise a controller arranged in proximity to the first pane for controlling the light output of the light emitting means.

The first and second panes may comprise glass, which is advantageous since insulated glass is commonly used to insulate the interior environment from the outside environment in e.g. buildings.

As an alternative, the first and second panes may be composed of plastic materials.

Further, the first and second panes may be made of high impact resistant material, which is particularly useful in e.g. automotive applications.

Another object of the present invention is to provide a window element comprising the lighting assembly as described above.

The window element may be curved for focusing the light output of the lighting assembly at particular positions of the interior environment and for controlling the shape of the illuminated area.

All references to “a/an/the [element, device, component, means, step, etc]” are to be interpreted as referring to at least one instance of said element, device, component, means, step, etc., unless explicitly stated otherwise. Further objectives of, features of, and advantages with, the present invention will become apparent when studying the following detailed disclosure, the drawings and the appended claims. Those skilled in the art realize that different features of the present invention can be combined to create embodiments other than those described in the following.

### BRIEF DESCRIPTION OF THE DRAWINGS

The above, as well as additional objects, features and advantages of the present invention, will be better understood through the following illustrative and non-limiting detailed description of preferred embodiments of the present invention, with reference to the appended drawings, in which:

FIG. 1 shows a cross-sectional view of a lighting assembly according to an embodiment of the present invention.

FIG. 2 shows a cross-sectional view of a lighting assembly according to another embodiment of the present invention.

FIG. 3 shows a cross-sectional view of a lighting assembly according to another embodiment of the present invention.

FIG. 4 shows a window comprising two window elements of which one element comprises a lighting assembly in accordance with the present invention.

All the figures are schematic, not necessarily to scale, and generally only show parts which are necessary in order to elucidate the invention, wherein other parts may be omitted or merely suggested.

### DESCRIPTION OF PREFERRED EMBODIMENTS

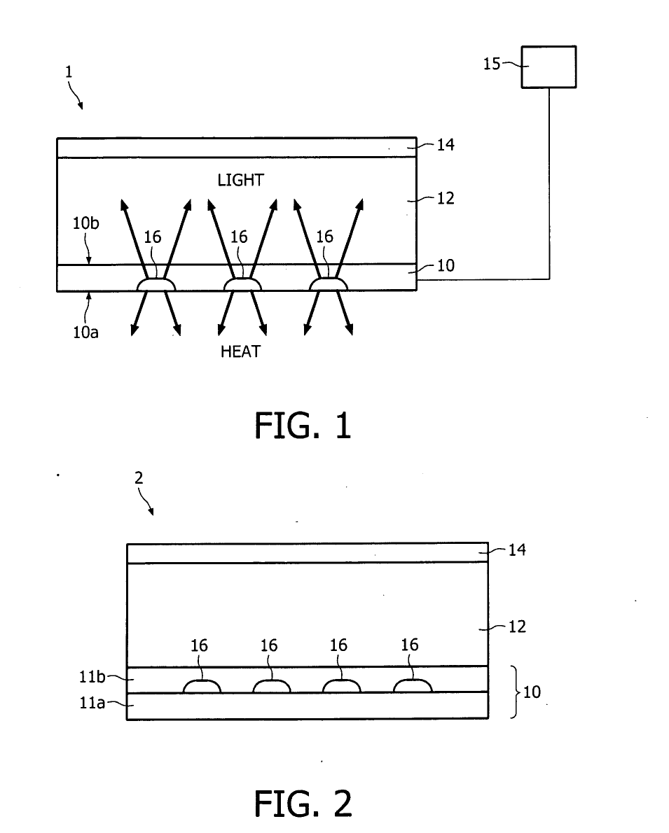

With reference to FIG. 1, a first embodiment of the present invention will be described below.

FIG. 1 shows a cross-sectional view of a lighting assembly 1 according to an embodiment of the present invention. The lighting assembly 1 comprises a first pane 10 and a second pane 14 spaced apart from each other by an insulating means 12. The lighting assembly 1 also comprises lighting means 16 arranged at the first pane 10 in such a way that light emitted from the lighting means 16 is directed towards the second pane 14 and heat generated by the lighting means 16 is directed in the opposite direction, as illustrated by arrows in FIG. 1. The lighting means 16 are preferably arranged at a peripheral face of the first pane 10 of the lighting assembly 1, i.e. either in the first pane 10 as shown in FIG. 1 or at the face 10a of the first pane 10 opposite to the face 10b of the first pane 10 in contact with the thermally insulating means 12. However, the lighting means 16 may also be arranged at the face 10b of the first pane 10.

In a configuration, the faces of the first 10 and second 14 panes spaced apart from each other by the thermally insulating means 12 are parallel; however, other configurations may be implemented in which the surfaces of the first 10 and second 14 panes are not parallel.

Both first and second panes may be composed of light-transmitting material, preferably transparent material, so that light emitted from light sources other than the lighting means 16 of the lighting assembly 1, such as daylight, can contribute to the light transmitted through the lighting assembly 1 from the first pane 10 to the second pane 14.

Preferably, the first pane 10 comprises material of high thermal conductivity such as high thermal conductive glass, and the thermally insulating means 12 comprises a material of low thermal conductivity. Alternatively, the thermally insulating means 12 may be vacuum or a gas of low thermal conductivity.

In an embodiment of the present invention, the second pane 14 of the lighting assembly 1 comprises a single pane, as shown in FIG. 1. However, the second pane 14 may alternatively comprise a plurality of panes arranged in layers.

The first pane of the lighting assembly may be a single pane at which the lighting means are arranged, as shown in FIG. 1. However, a plurality of panes arranged in layers may be used in order to further minimize the heat transfer from the first pane to the second pane.

It will be appreciated by a person skilled in the art that any type of light sources may be used in the lighting assembly of the present invention. In a preferred embodiment, however, light emitting diodes are used. These types of light sources are advantageous since they are small and therefore easily incorporated in the lighting assembly. Further, light emitting diodes can be selected so that the level of infrared radiation contained in their output power spectra is low in order to minimize the generation of heat by the radiation. In particular, polymer light emitting diodes can be employed.

Further, the light emitting means 16 can be selected depending on the application in which the lighting assembly is to be used. In a first alternative, the light emitting means 16 may be low-power light emitting diodes for avoiding glare and thereby avoiding annoyance for the persons using the light emitted by the lighting assembly 1. In another alternative, the light emitting means 16 may be high-power light emitting diodes for effectively directing light to the second pane and for increasing the light output of the lighting assembly 1. In yet a further alternative, the light emitting means 16 may be a combination of red, green and blue diodes for creating an illuminating surface emitting white light. Further, light emitting diodes can be selected so that the part of ultraviolet radiation in their output power spectra is very little, which is particularly advantageous when the lighting assembly is used in a window element for e.g. museums or exhibition centres for minimizing the degradation of objects such as paintings.

It will be appreciated by a person skilled in the art that the spatial distribution of the light emitting diodes on the first pane 10 may be arranged in any pattern in order to achieve any preferential illuminating pattern. Depending on the application, the density of light emitting diodes (number of diodes per unit area) would vary.

In yet a further embodiment, the lighting assembly 10 is provided with a controller 15 for controlling the output of the light emitted from the lighting means 16. The controller 15 may be employed to achieve smooth transitions from daylight to light provided by the lighting assembly 1 and in particular to compensate for light fading when daylight becomes insufficient. The use of light emitting diodes as light emitting means in combination with the controller 15 enables seamless transitions from daylight to artificial lighting since light emitting diodes are dimmable.

With reference to FIG. 2, another embodiment of the present invention is presented.

FIG. 2 shows a cross-sectional view of a lighting assembly 2, which is similar to the one described with reference to FIG. 1, but where the first pane 10 comprises two separate panes 11a, 11b arranged in layers. In the present embodiment, the first pane 10 comprises two layers 11a, 11b between which the lighting means 16 are arranged. This arrangement allows protection of the lighting means 16 from difficult conditions of the outside environment, such as humidity, and thereby extends lifetime of the lighting means 16.

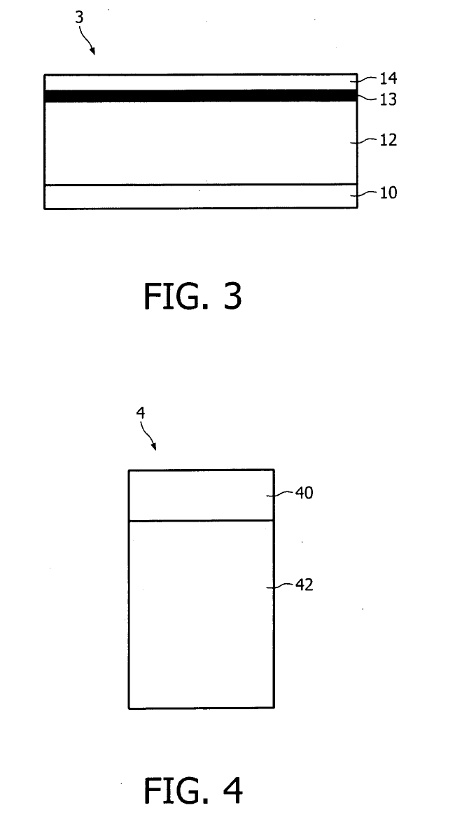

With reference to FIG. 3, another embodiment of the present invention is presented.

FIG. 3 shows a cross-sectional view of a lighting assembly 3, which is similar to the one described with reference to FIG. 1, but which has a heat reflective layer 13 arranged between the thermally insulating means 12 and the second pane 14 for reflecting infrared radiation emitted from the lighting means 16 towards the first pane 10. Alternatively, a heat reflective coating 13 may be applied on the face of the second pane 14 which is in contact with the thermally insulating means 12.

In a preferred embodiment, the first pane 10 and the second pane 14 are made of glass, which is advantageous since insulated glass is commonly used to insulate the interior of a building from the outside environment. Thus, standard materials can be used to implement the present invention. In another embodiment, the first and second panes 10 and 14 consist of plastic materials.

With reference to FIG. 4, another embodiment of the present invention is presented.

FIG. 4 shows a window 4 comprising two window elements 40 and 42 of which a first element 40 comprises a lighting assembly of the kind described in the above embodiments and a second element 42 comprises standard material, such as e.g. insulated glass. Standard insulated glass comprises two glass panes spaced apart from each other by a thermally insulating means.

In a preferred configuration, the first window element 40 is located above the second window element 42 for optimizing the angle of incidence of the light emitted from the lighting means 16 of the lighting assembly of the present invention. However, depending on the application, any kind of configuration, in which the lighting assembly of the present invention is used, may be implemented. In the present embodiment, the first pane 10 of the lighting means represents the exterior face of the window element 40 while the second pane 14 of the lighting means represents the interior face of the window element 40. Outside air convection is therefore used to cool the first pane 10 for transferring the heat generated by the lighting means 16 of the lighting assembly to the outside. Thus, heat conduction from the interior is facilitated and eventual additional equipments, such as air conditioners, requiring additional space, energy and cost are avoided.

It is, for instance, common that constant light levels are used in working environments and that a smooth transition between varying daylight conditions may be difficult to achieve. Using a window element in accordance with embodiments of the present invention in e.g. an office building provides comfortable interior lighting conditions to people working in the building. When daylight is fading, people can switch on the light from the window element. The lighting means integrated in the window element, through which natural daylight also enters the building, compensate for the deteriorating exterior light conditions. Smooth transitions can be obtained by means of the dimmable property of light emitting diodes controlled by the controller.

In yet a further embodiment, the window element may be curved for focusing the light emitted from the lighting means of the lighting assembly at particular locations of the interior environment and for controlling the shape of the focused light rays.

The present invention is applicable in any lighting applications where heat management in the interior environment receiving the light emitted from the lighting means is necessary. In particular, the present invention is applicable in artificial lighting for e.g. office buildings, individual homes or greenhouses, in horticulture lighting, in ambient lighting for special interior effects, and in automobile lighting for e.g. glass roofs/windows in cars, busses, trains, etc. for functional purposes and/or for compensation of the fading of the daylight.

Although the invention above has been described in connection with preferred embodiments of the invention, it will be evident for a person skilled in the art that several modifications are conceivable without departing from the scope of the invention as defined by the following claims.

1. Lighting assembly comprising:
a first pane,
a second pane and
a lighting source, wherein said first and second panes are spaced apart from each other by a thermally insulating layer and wherein said lighting source is arranged at said first pane to direct light emitted from said lighting source in a direction towards said second pane and to direct heat generated by said lighting means in an opposite direction away from said second pane.

2. The lighting assembly as defined in claim 1, wherein faces of said first and second panes are parallel.

3. The lighting assembly as defined in claim 1, wherein said first and second panes are light-transmissive.

4. The lighting assembly as defined in claim 1, wherein said first pane comprises material of high thermal conductivity.

5. The lighting assembly as defined in claim 1, wherein said thermally insulating layer comprises at least one material selected from the group consisting of: a material of low thermal conductivity, vacuum and a gas of low thermal conductivity.

6. The lighting assembly as defined in claim 1, wherein said second pane comprises a plurality of panes arranged in layers.

7. The lighting assembly as defined in claim 1, wherein said first pane comprises at least two panes arranged in layers between which said lighting source is arranged.

8. The lighting assembly as defined in claim 1, wherein a reflective layer is arranged between said thermally insulating layer and said second pane for reflecting infrared radiation generated by said lighting source towards said first pane.

9. The lighting assembly as defined in claim 1, wherein said lighting source comprises one or more light emitting diodes.

10. The lighting assembly as defined in claim 1, wherein said light emitting source comprises at least one light emitting diode selected from the group consisting of: low-power light emitting diodes for avoiding glare, high-power light emitting diodes for directing light, and red, green and blue diodes for generating white light.

11. The lighting assembly as defined in claim 1, wherein a controller is arranged in proximity to said first pane to control the light emitted from said lighting source.

12. The lighting assembly as defined in claim 1, wherein said first and second panes comprise glass.

13. The lighting assembly as defined in claim 1, wherein said first and second panes comprise plastic materials.

14-16. (canceled)
